(19) United States
(12) Patent Application Publication
(10) Pub. No.: US 2026/0186207 A1
(43) Pub. Date: Jul. 2, 2026

(54) OPTICAL FIBER CUTTING DEVICE AND OPTICAL FIBER CUTTING METHOD

(71) Applicant: Fujikura Ltd., Tokyo (JP)

(72) Inventor: Ryo Hasegawa, Sakura-shi (JP)

(73) Assignee: Fujikura Ltd., Tokyo (JP)

(21) Appl. No.: 19/130,407

(22) PCT Filed: Dec. 11, 2023
(86) PCT No.: PCT/JP2023/044193

§ 371 Date: May 15, 2025

(30) Foreign Application Priority Data
Dec. 9, 2022 (JP) 2022-197131

(51) Int. Cl. G02B 6/25

(52) U.S. Cl. CPC G02B 6/25

(57) ABSTRACT

An optical fiber cutting device includes a first gripping portion that grips an optical fiber, a second gripping portion that grips the optical fiber, a scratching blade that scratches the optical fiber between the first gripping portion and the second gripping portion, a backstop portion that restricts bending of the optical fiber, a detector that detects a position of the optical fiber with respect to the backstop portion, and a position adjuster that adjusts a position of the backstop portion based on the detected position of the optical fiber.

### CROSS-REFERENCE TO RELATED APPLICATIONS

The present application is a national phase application of International Application No. PCT/JP2023/044193, filed Dec. 11, 2023, which claims priority to Japanese Patent Application No. 2022-197131, filed Dec. 9, 2022. The contents of these applications are incorporated herein by reference in their entirety.

### BACKGROUND

### Technical Field

The present invention relates to an optical fiber cutting device and an optical fiber cutting method.

### Discussion of the Background

In the related art, an optical fiber cutting device has been known that scratches an optical fiber and cuts the optical fiber by tensile stress. The optical fiber cutting device of the related art has a holding plate that suppresses bending of the optical fiber when the optical fiber is scratched by a scratching blade (refer to, for example, PTL 1).

### PATENT LITERATURE

PTL 1: Japanese Patent Publication No. H6-294914

In order to perform good cutting, when the optical fiber is scratched by the scratching blade, a positional relationship between the optical fiber and the holding plate should be appropriately set, so that the optical fiber is not excessively bent. However, in the optical fiber cutting described in PTL 1, since a relative position between the optical fiber and the holding plate is fixed, a cutting quality becomes unstable depending on a size of a diameter of the optical fiber to be cut, and an angle defect or a shape defect of a cut surface of the optical fiber may occur. Further, even for optical fibers having the same specification, individual optical fibers may have a difference in diameter by a tolerance, and it has been difficult to stably obtain a good cut surface of the optical fiber.

### SUMMARY

One or more embodiments provide an optical fiber cutting device and an optical fiber cutting method capable of obtaining a good cut surface regardless of a diameter of an optical fiber.

An optical fiber cutting device of a first aspect of one or more embodiments includes: a first gripping portion that grips an optical fiber; a second gripping portion that grips the optical fiber; a scratching blade that scratches the optical fiber between the first gripping portion and the second gripping portion; a backstop portion that restricts bending of the optical fiber; a detector for detecting a position of the optical fiber with respect to the backstop portion; and a position adjuster for adjusting a position of the backstop portion based on the position of the optical fiber detected by the detector.

According to the optical fiber cutting device, the position adjuster adjusts the position of the backstop portion based on the position of the optical fiber detected by the detector. Therefore, the position of the backstop portion with respect to the position of the optical fiber can be appropriately set. Therefore, it is possible to obtain a good cut surface of the optical fiber regardless of an outer diameter of the optical fiber.

At a time when the optical fiber is scratched by the scratching blade, the backstop portion may restrict bending of the optical fiber.

The detector may include a sensor unit (example of a sensor) that measures a pressing force received by the backstop portion from the optical fiber, and a detection unit that detects the position of the optical fiber based on a measured value of the sensor unit.

The position adjuster may include an electric actuator that moves the backstop portion, and a control unit (example of a controller) that controls the electric actuator based on the position of the optical fiber.

The sensor unit may include an elastic member and a strain gauge that measures strain of the elastic member.

The first gripping portion and the second gripping portion may apply tension to the optical fiber.

The detection unit may detect a position of an outer surface of the optical fiber facing the backstop portion.

The sensor unit may include the one strain gauge, or a plurality of the strain gauges.

The optical fiber cutting device may include a lock mechanism that restricts movement of the backstop portion at the time of scratching by the scratching blade.

An optical fiber cutting method according to a second aspect of one or more embodiments includes: prior to scratching an optical fiber by using a scratching blade that scratches the optical fiber between a first gripping portion and a second gripping portion that grip the optical fiber, and a backstop portion that restricts bending of the optical fiber at a time of scratching by the scratching blade, a step of detecting a position of the optical fiber facing the backstop portion; and a step of adjusting a position of the backstop portion based on the detected position of the optical fiber.

According to the optical fiber cutting method, the position of the backstop portion is adjusted based on the detected position of the optical fiber. Therefore, the position of the backstop portion with respect to the position of the optical fiber can be appropriately set. Therefore, it is possible to obtain a good cut surface of the optical fiber regardless of an outer diameter of the optical fiber.

One or more embodiments provide an optical fiber cutting device and an optical fiber cutting method capable of obtaining a good cut surface of an optical fiber regardless of a diameter of the optical fiber.

### BRIEF DESCRIPTION OF THE DRAWINGS

FIG. 1 is a front view showing an optical fiber cutting device of one or more embodiments.

FIG. 2 is a front view showing the optical fiber cutting device of one or more embodiments.

FIG. 3 is a plan view showing an entirety of the optical fiber cutting device of one or more embodiments.

FIG. 4 is a plan view showing the optical fiber cutting device of one or more embodiments.

FIG. 5 is a front view showing the optical fiber cutting device of one or more embodiments.

FIG. 6 is a perspective view showing the optical fiber cutting device of one or more embodiments.

FIG. 7 is a perspective view showing the optical fiber cutting device of one or more embodiments.

FIG. 8 is a schematic view showing the optical fiber cutting device of one or more embodiments.

FIG. 9 is a schematic view for describing an operation of the optical fiber cutting device of one or more embodiments.

FIG. 10 is a schematic view for describing the operation of the optical fiber cutting device of one or more embodiments.

FIG. 11 is a schematic view for describing the operation of the optical fiber cutting device of one or more embodiments.

FIG. 12 is a schematic view for describing the operation of the optical fiber cutting device of one or more embodiments.

FIG. 13 is a front view showing a modification example of the optical fiber cutting device of one or more embodiments.

### DESCRIPTION OF ONE OR MORE EMBODIMENTS

An optical fiber cutting device according to embodiments will be described in detail with reference to the drawings.

### Optical Fiber Cutting Device

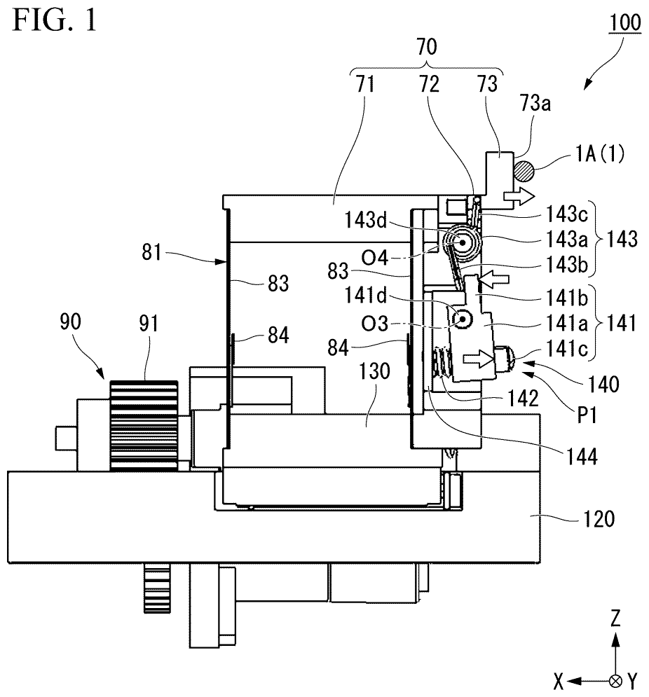

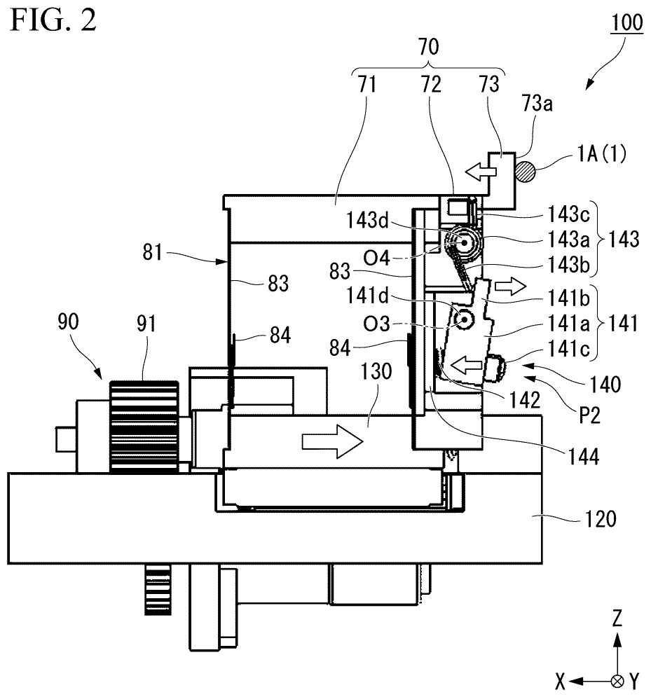

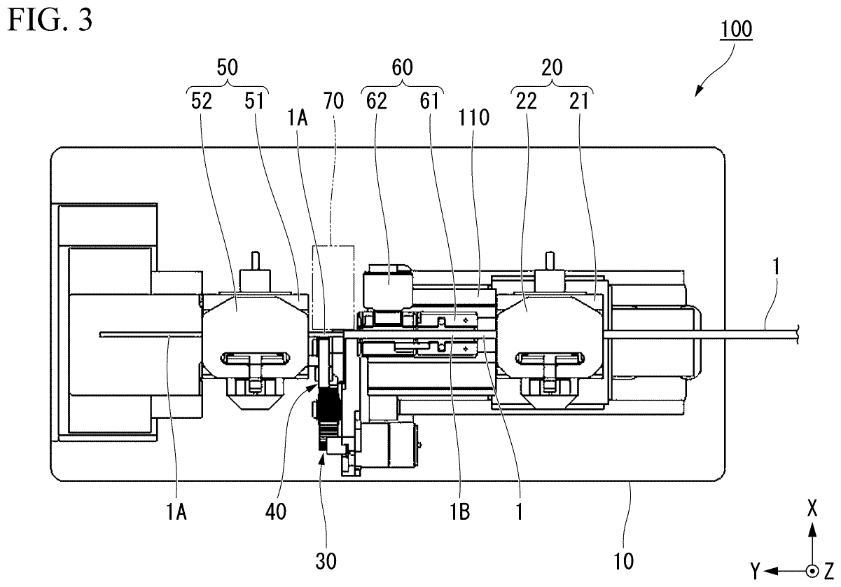

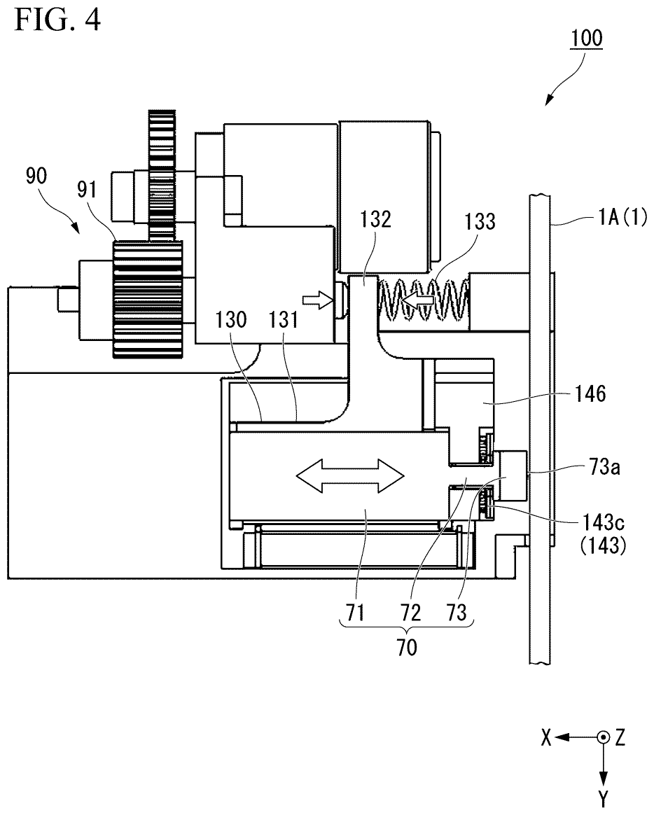

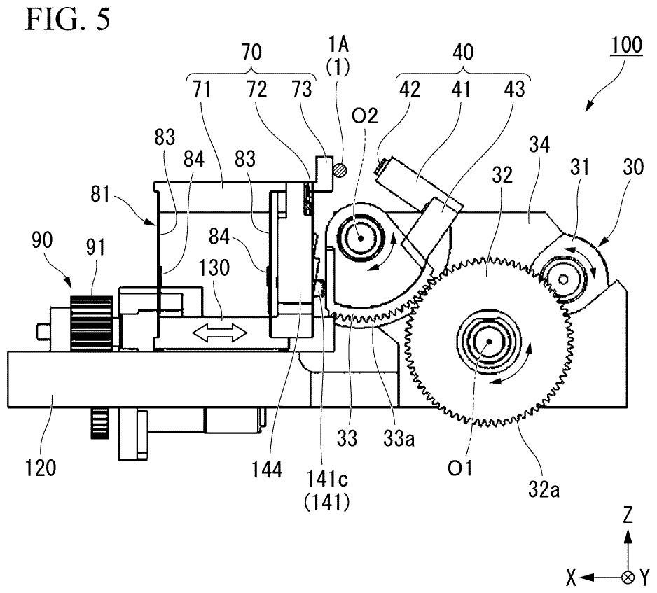

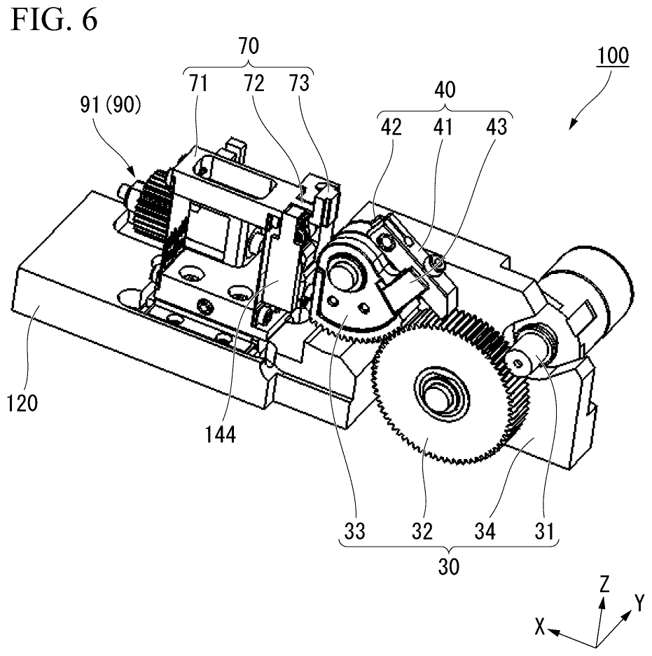

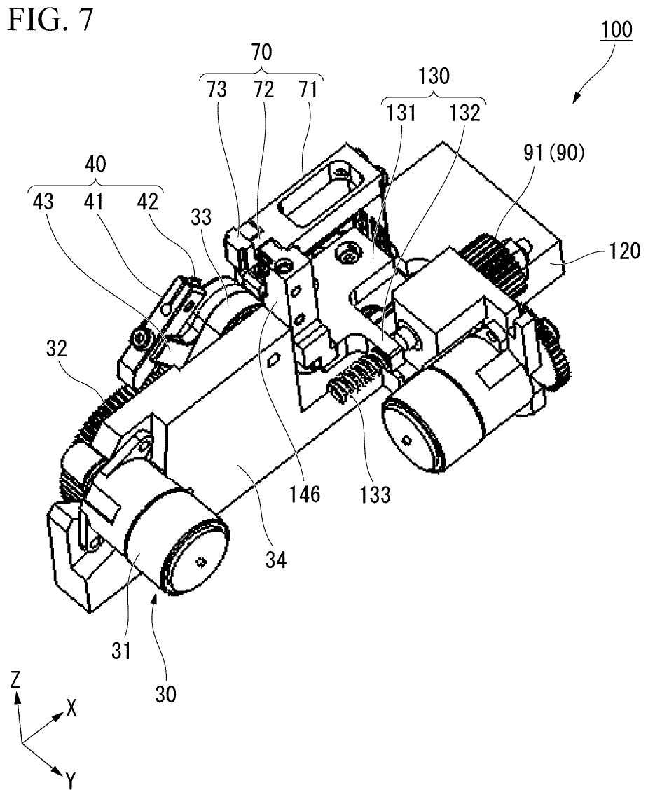

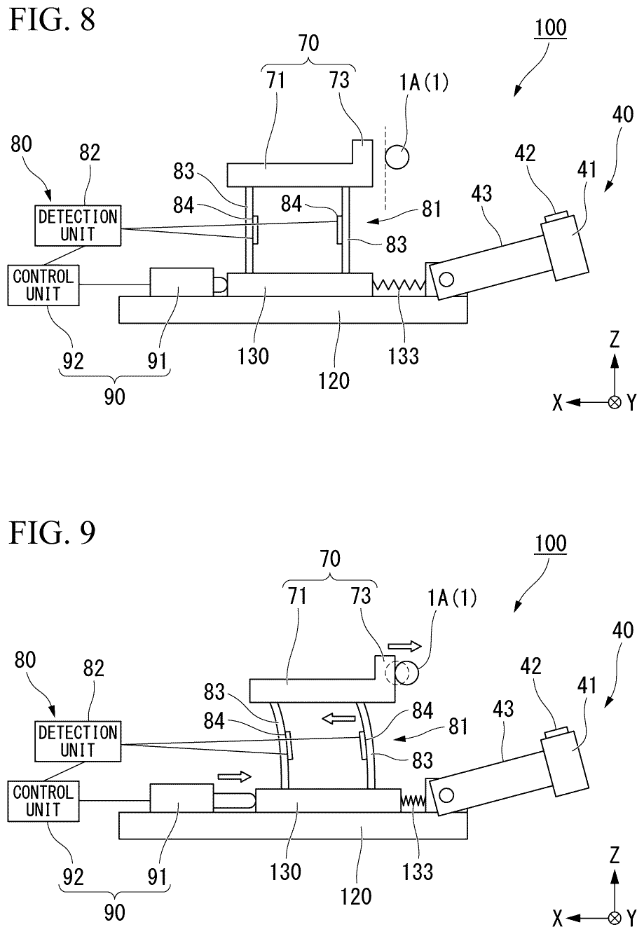

FIGS. 1 and 2 are front views showing an optical fiber cutting device of one or more embodiments. FIG. 3 is a plan view showing an entirety of the optical fiber cutting device of one or more embodiments. FIG. 4 is a plan view showing the optical fiber cutting device of one or more embodiments. FIG. 5 is a front view showing the optical fiber cutting device of one or more embodiments. FIGS. 6 and 7 are perspective views showing the optical fiber cutting device of one or more embodiments. FIG. 8 is a schematic view showing the optical fiber cutting device of one or more embodiments.

As shown in FIG. 3, an optical fiber cutting device 100 of one or more embodiments is configured to include a base member 10, a movable gripping portion 20 (first gripping portion), a fixed gripping portion 50 (second gripping portion), a scratch formation portion 40, a drive unit 30, a backstop portion 70, detector 80 (detection mechanism; refer to FIG. 8), and position adjuster 90 (position adjusting mechanism; refer to FIG. 8), a fiber holder holding stand 110 (fiber holder holding portion), a pedestal portion 120 (refer to FIG. 1), a support base portion 130 (refer to FIG. 1), and a lock mechanism 140 (refer to FIG. 1).

The optical fiber cutting device 100 is a cutting device that forms an initial scratch in the optical fiber 1 to which tension is applied and grows the initial scratch to cleave the optical fiber 1, thereby cutting the optical fiber 1.

The optical fiber 1 is composed of a bare optical fiber 1A made of glass and a coating portion 1B made of resin that covers an outer peripheral surface of the bare optical fiber 1A. By removing the coating portion 1B of the optical fiber 1, the bare optical fiber 1A made of glass is exposed. The optical fiber 1 is held by the optical fiber cutting device 100 in a state where the bare optical fiber 1A is exposed, and is cut at the portion of the bare optical fiber 1A. Alternatively, the bare optical fiber 1A is held by the optical fiber cutting device 100 in a state of being covered with the coating portion 1B, and is cut in a state of being covered with the coating portion 1B.

The optical fiber cutting device 100 is placed on a placement surface. Viewing from a direction along a normal line of the placement surface will be referred to as a plan view.

Hereinafter, directions may be referred to using an XYZ orthogonal coordinate system. Two orthogonal axes on the placement surface are defined as an X axis and a Y axis. A Z axis is orthogonal to the X axis and the Y axis. The Z axis is a normal line of the placement surface. The Y axis is along a longitudinal direction of the optical fiber cutting device 100 in a plan view. The Y axis coincides with a central axis of the optical fiber 1 gripped by the optical fiber cutting device 100. The X axis is along a lateral direction of the optical fiber cutting device 100 in a plan view.

A positive direction in the Y-axis (Y-axis positive direction) is one side of a length direction of the optical fiber 1. A negative direction in the Y-axis (Y-axis negative direction) is a direction opposite to the Y-axis positive direction. A positive direction in the X-axis (X-axis positive direction) is a direction from left to right when facing the Y-axis positive direction. A positive direction of the Z-axis (Z-axis positive direction) is a direction facing upward. An X-axis negative direction is a direction opposite to the X-axis positive direction. A Z-axis negative direction is a direction opposite to the Z-axis positive direction. In particular, in a case of representing directions along the X-axis, the Y-axis, and the Z-axis without distinguishing the positive direction and the negative direction, the directions are referred to as an X-axis direction, a Y-axis direction, and a Z-axis direction.

The base member 10 has a rectangular shape of which a longitudinal direction is along the Y-axis direction in a plan view.

The fixed gripping portion 50 determines a position of the optical fiber 1 in the Y-axis direction by gripping the optical fiber 1. The fixed gripping portion 50 includes a gripping portion main body 51 and a pressing member 52. A guide groove for positioning the optical fiber 1 is formed on an upper surface of the gripping portion main body 51. The pressing member 52 grips the optical fiber 1 with the gripping portion main body 51.

The fixed gripping portion 50 may grip a portion where the bare optical fiber 1A of the optical fiber 1 is exposed or may grip a portion where the bare optical fiber 1A is covered with the coating portion 1B.

The movable gripping portion 20 determines the position of the optical fiber 1 in the Y-axis direction by gripping the optical fiber 1. The movable gripping portion 20 includes a gripping portion main body 21 and a pressing member 22. A guide groove for positioning the optical fiber 1 is formed on an upper surface of the gripping portion main body 21. The pressing member 22 grips the optical fiber 1 with the gripping portion main body 21. The movable gripping portion 20 is located at a position separated from the fixed gripping portion 50 in the Y-axis negative direction. The movable gripping portion 20 is located on a Y-axis negative direction side with respect to the fiber holder holding stand 110.

The movable gripping portion 20 may grip a portion where the bare optical fiber 1A of the optical fiber 1 is exposed or may grip a portion where the bare optical fiber 1A is covered with the coating portion 1B.

The movable gripping portion 20 is movable in the Y-axis direction by a drive mechanism (not shown). The movable gripping portion 20 applies tension to the optical fiber 1 by moving in a direction (Y-axis negative direction) away from the fixed gripping portion 50.

The fiber holder holding stand 110 is located at a position separated from the fixed gripping portion 50 in the Y-axis negative direction. A fiber holder 60 can be placed on the fiber holder holding stand 110. The fiber holder holding stand 110 holds the placed fiber holder 60.

The fiber holder 60 grips the optical fiber 1 between the movable gripping portion 20 and the scratch formation portion 40. The fiber holder 60 has a holder base 61 and a pressing member 62. A guide groove for positioning the optical fiber 1 is formed on an upper surface of the holder base 61. The pressing member 62 grips the optical fiber 1 with the holder base 61. The pressing member 62 is rotatably connected to the holder base 61. The pressing member 62 can switch between a form of gripping the optical fiber 1 with the holder base 61 and a form of releasing the optical fiber 1.

As shown in FIGS. 5, 6, and 7, the scratch formation portion 40 forms an initial scratch on the bare optical fiber 1A of the optical fiber 1. The scratch formation portion 40 includes a scratching blade holder 41, a scratching blade 42, and a connection member 43.

The scratching blade holder 41 is formed in a rectangular columnar shape. An attachment portion to which the scratching blade 42 is attached is formed on a tip of the scratching blade holder 41.

The scratching blade 42 is attached to the scratching blade holder 41 to protrude from a tip of the scratching blade holder 41. The scratching blade 42 takes a posture in which a thickness direction is directed toward the Y-axis direction. The scratching blade 42 scratches the bare optical fiber 1A of the optical fiber 1 (that is, forms an initial scratch). Alternatively, the scratching blade 42 scratches the bare optical fiber 1A through the coating portion 1B of the optical fiber 1 with respect to the bare optical fiber 1A covered with the coating portion 1B.

The connection member 43 connects the scratching blade holder 41 and a rotation member 33 to each other.

Since the scratch formation portion 40 is connected to the rotation member 33 of the drive unit 30, the scratch formation portion 40 rotates about a rotation axis O2 (refer to FIG. 5) of the rotation member 33.

As shown in FIG. 3, the scratch formation portion 40 is located on the Y-axis negative direction side with respect to the fixed gripping portion 50. The scratch formation portion 40 is located on a Y-axis positive direction side with respect to the movable gripping portion 20. Therefore, the scratch formation portion 40 can scratch (that is, form an initial scratch on) the optical fiber 1 (specifically, the bare optical fiber 1A) to which tension is applied by the fixed gripping portion 50 and the movable gripping portion 20 between the fixed gripping portion 50 and the movable gripping portion 20. The scratch formation portion 40 is located on the Y-axis positive direction side with respect to the fiber holder holding stand 110.

As shown in FIG. 5, the drive unit 30 includes a drive source 31, an intermediate gear 32, the rotation member 33, and a support wall 34.

The drive source 31 is, for example, a motor. A plurality of tooth portions 32a are formed on an outer peripheral edge of the intermediate gear 32. The tooth portion 32a protrudes radially outward of the intermediate gear 32. The intermediate gear 32 is rotatably supported by the support wall 34. The intermediate gear 32 can rotate about a rotation axis O1. The rotation axis O1 is along the Y-axis direction. The intermediate gear 32 is rotated by the drive source 31.

The rotation member 33 is a circular sector-shaped plate body. A plurality of tooth portions 33a are formed on an outer peripheral edge of the rotation member 33. The tooth portion 33a projects radially outward of the rotation member 33. The rotation member 33 is rotatably supported by the support wall 34. The rotation member 33 can rotate about the rotation axis O2. The rotation axis O2 is along the Y-axis direction. The tooth portion 33a of the rotation member 33 meshes with the tooth portion 32a of the intermediate gear 32. The rotation member 33 rotates with the rotation of the intermediate gear 32. The support wall 34 is parallel to an XZ plane.

The backstop portion 70 has a function of restricting the bending of the optical fiber 1 at the time of scratching. As shown in FIG. 3, the backstop portion 70 is provided on a side opposite to the scratch formation portion 40 with respect to the optical fiber 1. That is, in a plan view, the backstop portion 70 is provided on a side opposite to the scratching blade 42 with the optical fiber 1 interposed therebetween in the X-axis direction (refer to FIG. 5).

As shown in FIGS. 1 and 4, the backstop portion 70 includes a base portion 71, an extension portion 72, and a pressure-receiving wall 73. As shown in FIG. 4, the base portion 71 has a rectangular plate shape along an XY plane. The base portion 71 has a rectangular shape of which a longitudinal direction is along the X-axis direction in a plan view. The extension portion 72 extends in the X-axis negative direction from an end in the X-axis negative direction of the base portion 71.

As shown in FIG. 1, the pressure-receiving wall 73 protrudes upward (Z-axis positive direction) from the end in the extending direction of the extension portion 72. The pressure-receiving wall 73 has a rectangular plate shape along a YZ plane. The pressure-receiving wall 73 faces the optical fiber 1. An outer surface 73a (a surface on an X-axis negative direction side) of the pressure-receiving wall 73 is an abutting surface on which the optical fiber 1 abuts. The outer surface 73a of the pressure-receiving wall 73 may be flat, or may be a convexly or concavely curved surface.

The backstop portion 70 is provided at a position separated upward (Z-axis positive direction) from the support base portion 130.

The support base portion 130 is placed on the pedestal portion 120 to be movable in the X-axis direction. As shown in FIGS. 4 and 7, the support base portion 130 includes a main body portion 131 and an extension portion 132. The extension portion 132 extends in the Y-axis negative direction from the main body portion 131.

As shown in FIG. 8, the detector 80 includes a sensor unit 81 and a detection unit 82. The detector 80 detects a position of the optical fiber 1 with respect to the backstop portion 70 (pressure-receiving wall 73). Specifically, a position of an outer surface of the optical fiber 1 facing the backstop portion 70 (pressure-receiving wall 73) is detected.

In a detection step described later, the sensor unit 81 measures a pressing force applied to the backstop portion 70 from the optical fiber 1 when the backstop portion 70 abuts on the optical fiber 1. The sensor unit 81 is provided with an elastic member 83 and a strain gauge 84. The elastic member 83 and the strain gauge may be provided by one or a plurality. Preferably, the strain gauge may be provided in each of the elastic members 83. In one or more embodiments, the sensor unit 81 includes two elastic members 83 and the strain gauges 84 provided one for each of the elastic members.

The elastic member 83 is, for example, an elastic plate spring made of metal or resin. The elastic member 83 has a plate shape of which a thickness direction is directed to the X-axis direction in a state where the elastic member 83 is not bent and deformed. The elastic member 83 can be bent and deformed in the X-axis direction. The elastic member 83 in a state of not being bent and deformed extends upward (Z-axis positive direction) from the support base portion 130. A pair of elastic members 83 are disposed to face each other at a distance in the X-axis direction.

The strain gauge 84 is provided on each of the two elastic members 83. The strain gauge 84 is provided on one surface of the elastic member 83. The strain gauge 84 can be provided, for example, on an inner surface of the elastic member 83 (a surface where two elastic members 83 face each other). The strain gauge 84 measures strain caused by the deformation of the elastic member 83. Specifically, the strain gauge 84 measures bending strain of the elastic member 83.

More preferably, two strain gauges 84 provided on each surface where two elastic members 83 face each other, that is, four strain gauges 84 in total may be provided, and a bridge circuit may be formed by the four strain gauges 84. Accordingly, the bending deformation of the elastic member 83 can be measured with high sensitivity.

The sensor unit 81 can measure the pressing force applied to the backstop portion 70 from the optical fiber 1 by detecting the bending strain of the elastic member 83 with the strain gauge 84.

The detection unit 82 detects the position of the optical fiber 1 based on a measured value of the strain gauge 84.

The position adjuster 90 includes an electric actuator 91 (pressing portion) and a control unit 92. The position adjuster 90 can adjust a position of the backstop portion 70 based on the position of the optical fiber 1. The electric actuator 91 can move the backstop portion 70 together with the support base portion 130 in the X-axis negative direction by pressing the support base portion 130 in the X-axis negative direction. The electric actuator 91 includes, for example, a micrometer and a motor (drive source) that drives the micrometer.

The control unit 92 controls an operation of the electric actuator 91 based on the position of the optical fiber 1 obtained by the detection unit 82.

As shown in FIG. 1, the lock mechanism 140 includes a lock component 141, a first urging member 142, and a rotation member 143.

The lock component 141 includes a component body 141a, a protruding portion 141b, and a pressure-receiving projection portion 141c. The component body 141a is formed in a block shape (for example, a rectangular parallelepiped shape). The lock component 141 is rotatably supported by a support 144 at a first shaft portion 141d provided on the component body 141a. The lock component 141 can rotate about a rotation axis O3 of the first shaft portion 141d. The rotation axis O3 is along the Y-axis direction. The protruding portion 141b protrudes upward from an upper end surface of the component body 141a. The pressure-receiving projection portion 141c protrudes forward (X-axis negative direction) from a front surface (surface on the X-axis negative direction side) of a lower portion of the component body 141a.

The first urging member 142 is provided on a rear surface (surface on an X-axis positive direction side) of the lock component 141. The first urging member 142 applies a reaction force to the support 144 to press the lower portion of the component body 141a forward (X-axis negative direction).

The rotation member 143 includes a coil portion 143a (pivot portion), a first extension portion 143b, and a second extension portion 143c. The coil portion 143a is rotatably supported by the support 144 in the second shaft portion 143d. The rotation member 143 can rotate axis a rotation axis O4 of the second shaft portion 143d. The rotation axis O4 is along the Y-axis direction.

The first extension portion 143b extends outward from the coil portion 143a. The second extension portion 143c extends outward from the coil portion 143a. An extending direction of the first extension portion 143b is different from an extending direction of the second extension portion 143c. The rotation member 143 is formed of, for example, metal. The rotation member 143 is, for example, a torsion spring. The first extension portion 143b is preferably attracted to the protruding portion 141b of the lock component 141 by a magnetic force.

The backstop portion 70 can be switched between a locked state P1 (refer to FIG. 1) and an unlocked state P2 (refer to FIG. 2). The locked state P1 is a state in which the movement of the backstop portion 70 is restricted, so that the bending of the optical fiber 1 can be restricted. The unlocked state P2 is a state in which the movement of the backstop portion 70 is not restricted.

FIG. 1 shows the backstop portion 70 being in the locked state P1. As shown in FIG. 1, in the locked state P1, the first urging member 142 presses the lower portion of the component body 141a forward (X-axis negative direction) so that the protruding portion 141b presses the first extension portion 143b of the rotation member 143 rearward (X-axis positive direction). When the first extension portion 143b is pressed, the second extension portion 143c of the rotation member 143 presses the pressure-receiving wall 73 of the backstop portion 70 forward (X-axis negative direction).

As shown in FIGS. 4 and 7, a front surface (surface on the X-axis negative direction side) of the base portion 71 of the backstop portion 70 abuts on a restriction member 146 so that forward movement thereof is restricted. Accordingly, a position of the backstop portion 70 in the X-axis direction is determined.

FIG. 2 shows the backstop portion 70 being in the unlocked state P2. As shown in FIG. 2, in the unlocked state P2, the rotation member 33 (refer to FIG. 5) presses the pressure-receiving projection portion 141c rearward (X-axis positive direction) so that the lock component 141 rotates, and the protruding portion 141b moves forward (X-axis negative direction). Since a pressing force of the protruding portion 141b against the first extension portion 143b becomes small, a pressing force of the second extension portion 143c against the pressure-receiving wall 73 becomes small. Accordingly, restriction of the movement of the backstop portion 70 is released, and the backstop portion 70 becomes movable rearward (X-axis positive direction).

As shown in FIGS. 4 and 7, the extension portion 132 of the support base portion 130 is urged rearward (X-axis positive direction) by a second urging member 133.

The electric actuator 91 adjusts a position of the support base portion 130 in the X-axis direction. The electric actuator 91 can press the extension portion 132 of the support base portion 130 forward (X-axis negative direction).

### Optical Fiber Cutting Method

Next, a method for cutting the optical fiber 1 using the optical fiber cutting device 100 will be described. Hereinafter, a method for cutting the optical fiber 1 in a state where the bare optical fiber 1A is exposed will be described.

### (Preparation Step)

As shown in FIG. 3, the optical fiber 1 in which the bare optical fiber 1A is exposed in a portion including a tip is prepared. The fixed gripping portion 50 grips the bare optical fiber 1A of the optical fiber 1. The movable gripping portion 20 grips, for example, the optical fiber 1 in the portion where the coating portion 1B is formed. Tension is applied to the optical fiber 1 by moving the movable gripping portion 20 in a direction away from the fixed gripping portion 50 (Y-axis negative direction).

As shown in FIGS. 2 and 5, in an initial state, the rotation member 33 presses the pressure-receiving projection portion 141c rearward (X-axis positive direction). Therefore, the backstop portion 70 is in the unlocked state P2.

As shown in FIG. 8, in the initial state, the optical fiber 1 (bare optical fiber 1A) is separated forward (X-axis negative direction) with respect to the pressure-receiving wall 73 of the backstop portion 70. Therefore, the elastic member 83 is not bent and deformed. The bending strain of the elastic member 83 that is measured by the strain gauge 84 is small. The control unit 92 can determine from the measured value of the strain gauge 84 obtained by the detection unit 82 that the bare optical fiber 1A does not press the pressure-receiving wall 73.

### (Detection Step)

As shown in FIG. 9, the control unit 92 determines a control value of the electric actuator 91 based on the fact that an outer surface of the bare optical fiber 1A is at a position where the pressure-receiving wall 73 is not pressed. The control unit 92 operates the electric actuator 91. The electric actuator 91 moves the backstop portion 70 forward (X-axis negative direction) by pressing the support base portion 130 forward (X-axis negative direction).

The outer surface 73a of the pressure-receiving wall 73 of the backstop portion 70 abuts on the optical fiber 1. When the electric actuator 91 further moves the support base portion 130 forward (X-axis negative direction), the forward movement of the backstop portion 70 is restricted by the bare optical fiber 1A.

Since the forward movement of the backstop portion 70 is restricted but the support base portion 130 moves forward, the elastic member 83 is bent and deformed rearward (X-axis positive direction). Therefore, the bending strain of the elastic member 83 that is measured by the strain gauge 84 becomes large.

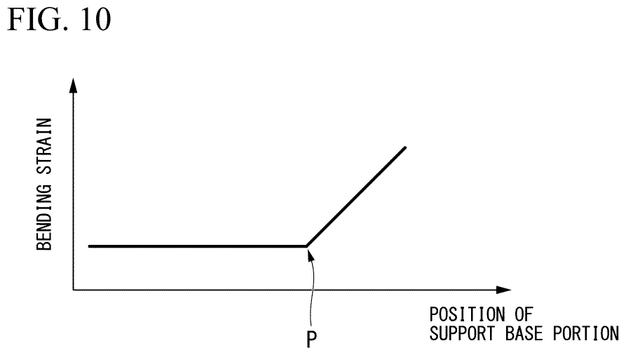

FIG. 10 is a graph showing a relationship between the position of the support base portion 130 in the X-axis direction and the bending strain of the elastic member 83. A horizontal axis indicates the position of the support base portion 130 in the X-axis direction. A vertical axis indicates the bending strain of the elastic member 83. As shown in FIG. 10, the bending strain increases as the support base portion 130 moves forward. A point at which the bending strain turns to increase (turning point P) represents a position of the bare optical fiber 1A when the bare optical fiber 1A abuts on the pressure-receiving wall 73. Here, the position of the bare optical fiber 1A is, specifically, a position of a location on the outer peripheral surface of the bare optical fiber 1A that abuts on the pressure-receiving wall 73.

It is preferable that an operation of moving the support base portion 130 and the backstop portion 70 forward by the electric actuator 91 to increase the bending strain of the elastic member 83 is repeated a plurality of times. Thus, the control unit 92 can obtain a lot of data about the point at which the bending strain turns to increase (turning point P), and can accurately determine the position of the bare optical fiber 1A.

### (Position Adjusting Step)

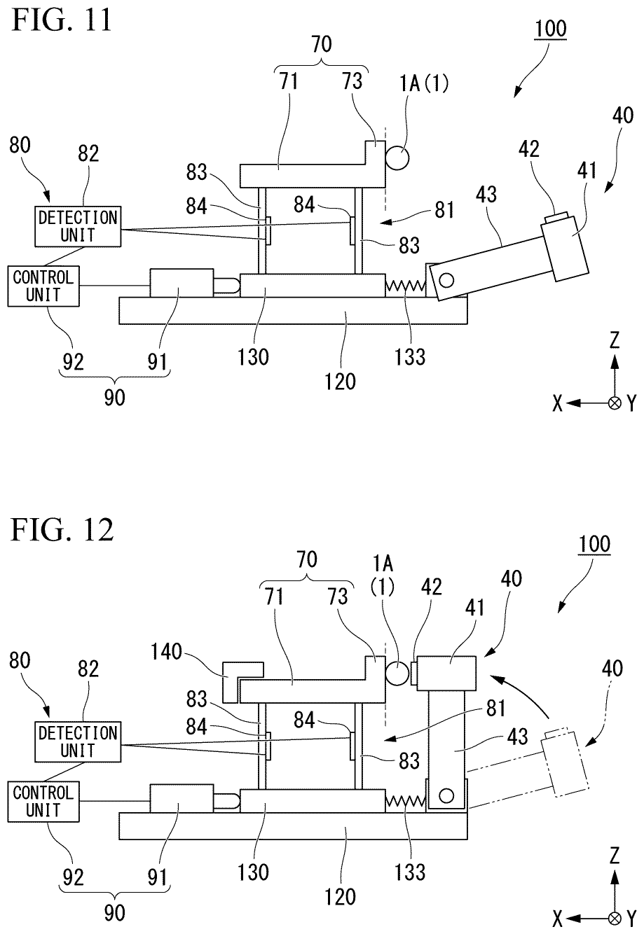

As shown in FIG. 11, the control unit 92 operates the electric actuator 91 based on the position of the bare optical fiber 1A. The electric actuator 91 disposes the backstop portion 70 at a position where the pressure-receiving wall 73 abuts on the bare optical fiber 1A. Although the pressure-receiving wall 73 abuts on the bare optical fiber 1A, it is desirable that the pressure-receiving wall 73 hardly applies any forward pressing force to the bare optical fiber 1A.

Alternatively, the electric actuator 91 may move the backstop portion 70 from the position where the pressure-receiving wall 73 abuts on the optical fiber 1 in a direction away from the bare optical fiber 1A so that a slight gap is provided between the pressure-receiving wall 73 and the outer surface of the optical fiber 1.

By disposing the backstop portion 70 at an appropriate position, the bending of the bare optical fiber 1A is restricted even though the bare optical fiber 1A receives a pressure from the scratching blade 42 at the time of scratching, and a good cut surface of the optical fiber 1 can be obtained.

A positional relationship between the backstop portion 70 (pressure-receiving wall 73) and the bare optical fiber 1A can be adjusted such that a preferable cut surface is obtained according to the application.

As shown in FIG. 5, the drive source 31 is operated to apply a force in a rotation direction (counterclockwise direction in FIG. 5) to the rotation member 33 via the intermediate gear 32. As shown in FIG. 1, when the rotation member 33 (refer to FIG. 5) rotates, the pressing of the rotation member 33 against the lock component 141 is released. Therefore, the backstop portion 70 is in the locked state P1. In the locked state P1, the first urging member 142 presses the lower portion of the component body 141a forward (X-axis negative direction) so that the protruding portion 141b presses the first extension portion 143b of the rotation member 143 rearward (X-axis positive direction). The second extension portion 143c of the rotation member 143 presses the pressure-receiving wall 73 of the backstop portion 70 forward (X-axis negative direction).

In the locked state P1, the movement of the backstop portion 70 rearward (X-axis positive direction) is restricted, so that the bending of the bare optical fiber 1A can be restricted. In this way, the lock mechanism 140 can restrict the movement of the backstop portion 70 in the X-axis direction when the bare optical fiber 1A is scratched by the scratching blade 42.

### Cutting Step

As shown in FIG. 12, the scratching blade holder 41 and the scratching blade 42 approach the bare optical fiber 1A with the rotation of the rotation member 33 (refer to FIG. 5) in the counterclockwise direction. The scratching blade 42 scratches the bare optical fiber 1A of the optical fiber 1 (that is, forms an initial scratch). A direction in which the scratching blade 42 scratches the bare optical fiber 1A (scratching direction) is the X-axis direction. The initial scratch grows due to the tension applied to the bare optical fiber 1A, and the bare optical fiber 1A is cleaved and cut.

In addition, a time when the backstop portion 70 restricts bending of the bare optical fiber 1A is not limited to a time of scratching the bare optical fiber 1A by the scratching blade 42. For example, in the locked state P1, before and after scratching the bare optical fiber 1A by the scratching blade 42, the position of the bare optical fiber 1A is fixed by the backstop portion 70. In this case, the bending of the bare optical fiber 1A is more reliably restricted by the backstop portion 70 in the cutting step.

By the above method, the optical fiber 1 in which the bare optical fiber 1A is exposed can be cut by using the optical fiber cutting device 100. The optical fiber 1 in which the bare optical fiber 1A is covered with the coating portion 1B can also be cut by the same method because the scratching blade 42 scratches the bare optical fiber 1A through the coating portion 1B.

### Effects of Optical Fiber Cutting Device and Optical Fiber Cutting Method of Embodiments

In the optical fiber cutting device 100 of one or more embodiments, the position adjuster 90 adjusts the position of the backstop portion 70 based on the position of the optical fiber 1 detected by the detector 80. Therefore, the position of the backstop portion 70 with respect to the position of the optical fiber 1 can be appropriately set. Therefore, a good cut surface of the optical fiber 1 can be obtained regardless of an outer diameter of the optical fiber 1. For example, even in a case where the optical fiber 1 having a large outer diameter is targeted, a good cut surface of the optical fiber 1 can be obtained.

The detector 80 includes the sensor unit 81 that measures a pressing force from the optical fiber 1 and the detection unit 82 that detects the position of the optical fiber 1 based on the measured value of the sensor unit 81. The detector 80 can accurately detect the position of the optical fiber 1 by the sensor unit 81 and the detection unit 82.

The position adjuster 90 includes the electric actuator 91 that moves the backstop portion 70 and the control unit 92 that controls the electric actuator 91 based on the position of the optical fiber 1. The position adjuster 90 can accurately adjust the position of the backstop portion 70 in the X-axis direction by the electric actuator 91 and the control unit 92.

The sensor unit 81 includes the elastic member 83 and the strain gauge 84 that measures the bending strain of the elastic member 83. With this configuration, the sensor unit 81 can accurately measure the pressing force from the optical fiber 1 to the backstop portion 70. The sensor unit 81 may include the one strain gauge 84, or a plurality of strain gauges 84.

Since the elastic member 83 is a plate spring, a structure of the sensor unit 81 can be simplified. Since the elastic member 83 is a plate spring, the pressing force from the optical fiber 1 to the backstop portion 70 can be accurately measured by measuring the bending strain.

Since the optical fiber cutting device 100 includes the lock mechanism 140, the backstop portion 70 can be in the locked state P1 when the scratching blade 42 of the scratch formation portion 40 scratches the optical fiber 1. In the locked state P1, the movement of the backstop portion 70 rearward (X-axis positive direction) is restricted, so that the bending of the optical fiber 1 can be restricted. Therefore, a scratched amount of the optical fiber 1 can be stabilized.

According to the optical fiber cutting method of one or more embodiments, the position of the backstop portion 70 is adjusted based on the position of the optical fiber 1 detected by the detector 80. Therefore, the position of the backstop portion 70 with respect to the position of the optical fiber 1 can be appropriately set. Therefore, a good cut surface of the optical fiber 1 can be obtained regardless of an outer diameter of the optical fiber 1. For example, even in a case where the optical fiber 1 having a large outer diameter is targeted, a good cut surface of the optical fiber 1 can be obtained.

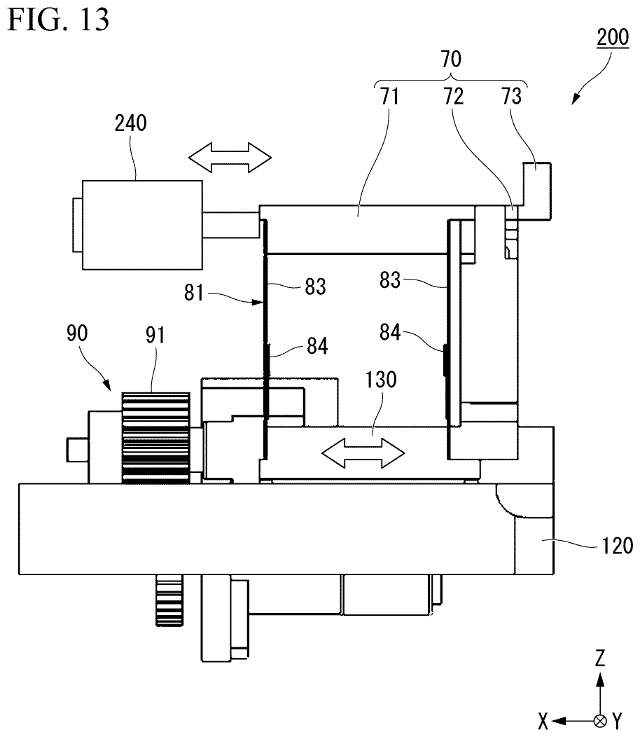

FIG. 13 is a front view showing a modification example of the optical fiber cutting device of one or more embodiments.

As shown in FIG. 13, an optical fiber cutting device 200 of the modification example is different from the optical fiber cutting device 100 (refer to FIG. 1) in that a lock mechanism 240 is provided instead of the lock mechanism 140 (refer to FIG. 1).

The lock mechanism 240 may be, for example, a drive mechanism such as a solenoid or a motor. The position in the X-axis direction of the lock mechanism 240 can adjusted. The lock mechanism 240 can switch between the locked state and the unlocked state of the backstop portion 70 by movement in the X-axis direction. In the locked state, the lock mechanism 240 is at a position behind the backstop portion 70 (in the X-axis positive direction) where the lock mechanism 240 can abut on a rear end of the backstop portion 70. Accordingly, the movement of the backstop portion 70 rearward (X-axis positive direction) can be restricted. In the unlocked state, the lock mechanism 240 is positioned rearward compared to the locked state and does not restrict the movement of the backstop portion 70 in the X-axis direction.

The lock mechanism 240 can restrict the movement of the backstop portion 70 in the X-axis direction when the optical fiber 1 is scratched by the scratching blade 42.

Since the optical fiber cutting device 200 has a simple structure of the lock mechanism 240, the optical fiber cutting device 200 can be reduced in size and cost.

In the optical fiber cutting device 100 of the above embodiments, the sensor unit 81 provided with a plurality of (two) elastic members 83 is used, but the number of the elastic members is not limited. The number of the elastic members may be one or a plurality (any number of two or more). The number of the strain gauges may be one or a plurality (any number of two or more).

In the optical fiber cutting device 100 of the above embodiments, the sensor unit 81 includes the elastic member 83 and the strain gauge 84, but the configuration of the sensor unit is not particularly limited. The sensor unit may be a pressure sensor that measures a pressing force from the optical fiber to the backstop portion. The sensor unit may be an optical sensor that optically detects the position of the backstop portion.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### REFERENCE SIGNS LIST

1: Optical fiber
1A: Bare optical fiber
1B: Coating portion
20: Movable gripping portion (first gripping portion)
40: Scratch formation portion
42: Scratching blade
50: Fixed gripping portion (second gripping portion)
70: Backstop portion
80: Detector
81: Sensor unit
82: Detection unit
83: Elastic member
84: Strain gauge
90: Position adjuster
91 Electric actuator
92: Control unit
100, 200: Optical fiber cutting device
140, 240: Lock mechanism

1. An optical fiber cutting device comprising:
a first gripping portion that grips an optical fiber;
a second gripping portion that grips the optical fiber;
a scratching blade that scratches the optical fiber between the first gripping portion and the second gripping portion;
a backstop portion that restricts bending of the optical fiber;
a detector that detects a position of the optical fiber with respect to the backstop portion; and
a position adjuster that adjusts a position of the backstop portion based on the detected position of the optical fiber.

2. The optical fiber cutting device according to claim 1, wherein, the backstop portion restricts the bending of the optical fiber when the scratching blade scratches the optical fiber.

3. The optical fiber cutting device according to claim 1, wherein the detector:
includes a sensor that measures a pressing force applied to the backstop portion by the optical fiber, and
detects the position of the optical fiber based on the measured pressing force.

4. The optical fiber cutting device according to claim 1, wherein the position adjuster includes:
an electric actuator that moves the backstop portion; and
a controller that controls the electric actuator based on the position of the optical fiber.

5. The optical fiber cutting device according to claim 3, wherein the sensor includes an elastic member and a strain gauge that measures strain of the elastic member.

6. The optical fiber cutting device according to claim 1, wherein the first gripping portion and the second gripping portion apply tension to the optical fiber.

7. The optical fiber cutting device according to claim 3, wherein the detector detects a position of an outer surface of the optical fiber facing the backstop portion.

8. The optical fiber cutting device according to claim 3, wherein the sensor includes an elastic member and strain gauges that each measure strain of the elastic member.

9. The optical fiber cutting device according to claim 1, further comprising:
a lock mechanism that restricts movement of the backstop portion when the scratching blade scratches the optical fiber.

10. An optical fiber cutting method for cutting an optical fiber using an optical fiber cutting device that comprises a backstop portion, a first gripping portion, a second gripping portion, and a scratching blade, the method comprising:
detecting a position of the optical fiber facing the backstop portion;
adjusting a position of the backstop portion based on the detected position of the optical fiber;
after adjusting the position of the backstop portion, scratching the optical fiber using the scratching blade between the first and the second gripping portions that grip the optical fiber that is restricted from bending by the backstop portion.
